(19) United States
(12) Patent Application Publication
(10) Pub. No.: US 2007/0150823 A1
(43) Pub. Date: Jun. 28, 2007

(54) Method for controlling on-screen display providing predetermined demo

(75) Inventor: Song Yeh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/645,398

(22) Filed: Dec. 26, 2006

(30) Foreign Application Priority Data
Dec. 23, 2005 (TW) 94146315

(51) Int. Cl. G09G 5/00; G06F 3/00

(52) U.S. Cl. 715/764; 345/581

(57) ABSTRACT

An exemplary method for controlling an on-screen display includes: generating a control signal and sending the control signal to a micro-controller unit; setting up a demo parameter which is stored in a register and which represents a demo of an on-screen display menu of according to the control signal by the micro-controller unit; and executing a display control program for pointing to a sub-program for displaying a predetermined demo of an on-screen display menu according to the demo parameter.

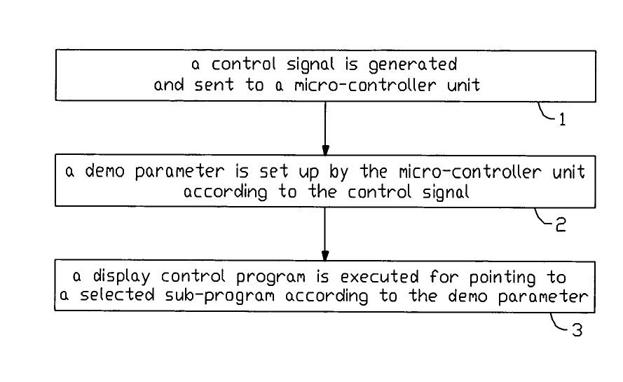

### FIELD OF THE INVENTION

The present invention relates to methods for controlling on-screen displays (OSDs), and more particularly to a method for controlling an on-screen display which provides a predetermined demo for a selected item of the on-screen display.

### GENERAL BACKGROUND

With the rapid popularization of computers and related apparatus in recent years, many display devices have been playing an increasingly important role in the use and enjoyment of electronic products. Popular display devices include cathode ray tube (CRT) displays and liquid crystal displays (LCDs). The performance of these display devices depends in large part on the calibration of display parameters by manufacturers before shipment from the factory, and on individual adjustment of the display parameters by an end user to achieve optimal viewing quality. The display parameters typically include, for e.g., contrast, brightness, vertical and horizontal sizes, and geometric shape integrity. An OSD provides an operator with interactive information to obtain an optimum display quality through adjustment of the above kinds of parameters. Typically, there are several selection buttons for an OSD device. When the operator pushes a selected button, a demand signal is generated, and the OSD device receives the demand signal and sends the demand signal to a micro-controller unit (MCU) therein. Thereby, contrast, brightness, vertical and horizontal sizes, etc can be controlled by the operator as desired. Further, the operator can clearly observe the results of the adjustments while performing the adjustments.

The OSD of a typical display device is browsed and utilized by manipulating several buttons, which can make operation of the OSD somewhat complicated. Further, the OSDs of display devices of different manufacturers may be different, and some of the functions of the various OSDs may even be conflicting. An operators can be confused when using the OSD of a particular display device, and can even mistakenly make an unwanted, irreversible change to the display. In such cases, the display device may need to be sent back to the supplier for correction.

What is needed, therefore, is a method for controlling an OSD of a display device which can overcome the above-described deficiencies.

### SUMMARY

In an exemplary embodiment, a method for controlling an on-screen display includes: generating a control signal and sending the control signal to a micro-controller unit; setting up a demo parameter which is stored in a register and which represents a demo of an on-screen display menu of according to the control signal by the micro-controller unit; and executing a display control program for pointing to a sub-program for displaying a predetermined demo of an on-screen display menu according to the demo parameter.

Other advantages and novel features will become more apparent from the following detailed description when taken in conjunction with the accompanying drawing.

### BRIEF DESCRIPTION OF THE DRAWING

The FIGURE is a flowchart of a method for controlling an on-screen display of a display device according to an exemplary embodiment of the present invention.

### DETAILED DESCRIPTION OF PREFERRED EMBODIMENTS

Reference will now be made to the drawing to describe the preferred embodiments in detail.

A display panel of a display device (not shown) can display a menu which shows display parameters of the display panel or a state of the display panel. The menu items can be selected from the group consisting of brightness of the display panel, contrast of the display panel, color balance of the display panel, sharpness of the display panel, horizontal position of the menu, vertical position of the menu, phase of the display panel, a clock of the display panel, and power saving mode of the display panel. This kind of menu is referred to herein as the OSD menu of the display panel.

Referring to the figure, this is a flowchart of a method for controlling an OSD of the display device according to an exemplary embodiment of the present invention is shown. The control method includes the following steps:

In step 1, a control signal is generated and sent to a micro-controller unit. The control signal can be generated by a demo option of a menu of the OSD, a key combination of a keyboard, or a program of a computer. The micro-controller unit may reside in the display device itself, or in an external device such as a computer. In the exemplary embodiment, the control signal is generated when an item of the OSD menu is selected by a user.

In step 2, a demo parameter is set up by the micro-controller unit according to the control signal. The demo parameter is stored in a register. In the illustrated embodiment, the register is a memory unit such as an electrically erasable programmable read-only memory (EEPROM). Each demo parameter is related to a sub-program for displaying a predetermined demo of the corresponding item of the OSD menu. That is, each sub-program can be selected by the corresponding demo parameter when the micro-controller unit receives the corresponding control signal.

In step 3, a display control program is executed for pointing to a selected sub-program according to the demo parameter. Thus a desired demo of the corresponding item of the OSD menu can be displayed on the display device when the selected sub-program is executed. A process of displaying the predetermined demo is performed by the micro-controller unit. The predetermined demo can be shown in a slide show automatically or by the user manually as desired. Each predetermined demo can be displayed by repeating the above-described step 1 to step 3. In an alternative embodiment, a predetermined record of voice for the corresponding item is played to explain a corresponding function of the item.

The display device provides a predetermined demo for the selected item of the OSD menu thereof, which demo demonstrates the predefined function of the item to an operator. This helps the operators to know the predefined function of the corresponding item, and to make desired operations to the OSD menu.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A method for controlling an on-screen display comprising:
generating a control signal and sending the control signal to a micro-controller unit;
setting up a demo parameter which is stored in a register and which represents a demo of an on-screen display menu of according to the control signal by the micro-controller unit; and
executing a display control program for pointing to a sub-program for displaying a predetermined demo of an on-screen display menu according to the demo parameter.

2. The method for controlling an on-screen display as claimed in claim 1, wherein the control signal is generated by a demo option of the on-screen display menu.

3. The method for controlling an on-screen display as claimed in claim 1, wherein the control signal is generated by a key combination of a keyboard.

4. The method for controlling an on-screen display as claimed in claim 1, wherein the control signal is generated by a program of a computer.

5. The method for controlling an on-screen display as claimed in claim 1, wherein the register comprises a memory unit.

6. The method for controlling an on-screen display as claimed in claim 5, wherein memory unit is an electrically erasable programmable read-only memory (EEPROM).

7. The method for controlling an on-screen display as claimed in claim 1, wherein each sub-program is selected by a corresponding demo parameter.

8. The method for controlling an on-screen display as claimed in claim 7, wherein the demo parameter is selected from the group consisting of brightness, contrast, color balance, sharpness, horizontal position of the on-screen display menu, vertical position of the on-screen display menu, phase, a clock, and power saving mode.

9. The method for controlling an on-screen display as claimed in claim 1, wherein a process of displaying the demo of the on-screen display menu is executed by the micro-controller unit.

10. A method of controlling an on-screen display comprising steps of:
generating a control signal and sending the control signal to a micro-controller unit;
setting up a demo parameter which represents a demo of an on-screen display menu of according to the control signal by the micro-controller unit; and
executing a display control program for pointing to a sub-program for displaying a predetermined demo of an on-screen display menu according to the demo parameter.

11. The method for controlling an on-screen display as claimed in claim 10, wherein the control signal is generated by a demo option of the on-screen display menu.

12. The method for controlling an on-screen display as claimed in claim 10, wherein the control signal is generated by a key combination of a keyboard.

13. The method for controlling an on-screen display as claimed in claim 10, wherein the control signal is generated by a program of a computer.

14. The method for controlling an on-screen display as claimed in claim 10, wherein the register comprises a memory unit.

15. The method for controlling an on-screen display as claimed in claim 14, wherein memory unit is an electrically erasable programmable read-only memory (EEPROM).

16. The method for controlling an on-screen display as claimed in claim 10, wherein each sub-program is selected by a corresponding demo parameter

17. The method for controlling an on-screen display as claimed in claim 16, wherein the demo parameter is selected from the group consisting of brightness, contrast, color balance, sharpness, horizontal position of the on-screen display menu, vertical position of the on-screen display menu, phase, a clock, and power saving mode.

18. The method for controlling an on-screen display as claimed in claim 10, wherein a process of displaying the demo of the on-screen display menu is executed by the micro-controller unit.
